(19) United States
(12) Patent Application Publication
(10) Pub. No.: US 2004/0042528 A1
(43) Pub. Date: Mar. 4, 2004

(54) Method and device for testing numerous different material samples

(76) Inventors: Thomas Brinz, Bissingen Unter Der Teck (DE); Wilhelm Maier, Ingbert (DE); Ulrich Simon, Aachen (DE)

Correspondence Address: KENYON & KENYON, ONE BROADWAY, NEW YORK, NY, 10004, US

(21) Appl. No.: 10/456,091

(22) Filed: Jun. 6, 2003

(30) Foreign Application Priority Data
Jun. 12, 2002 (DE) 102 25 994.1

(51) Int. Cl. G01J 5/00

(52) U.S. Cl. 374/121

(57) ABSTRACT

A device and a method for testing numerous different material samples on a substrate, in particular catalytically active material samples, having a temperature evaluation unit for determining a material temperature which includes an infrared radiation detection unit. The infrared radiation detection unit detects the numerous different material samples on the substrate using local resolution.

### FIELD OF THE INVENTION

The present invention relates to a method and device for testing numerous different material samples.

### BACKGROUND INFORMATION

In developing sensor materials and catalysts, combinatorial chemists frequently manufacture and test a wide range of different samples which may vary slightly in composition. For example, materials are tested to determine a sensitivity to a gas to be detected. In this regard, an infrared radiation detection unit may determine a variation in material temperature resulting from a reaction of the gas and the materials.

Up to now, the numerous different material samples have been measured individually. In one situation, numerous material samples are measured consecutively over time using one measurement unit, thereby taking a very long time to measure all material samples. In another situation, numerous material samples are measured simultaneously, which requires numerous measurement instruments and thus increases measurement complexity.

### SUMMARY OF THE INVENTION

An object of the present invention is to provide a method and device for testing numerous different material samples on a substrate, in particular catalytically active material samples. In accordance with an example embodiment of the present invention a temperature evaluation unit is provided for determining a material temperature which includes an infrared radiation detection unit, thereby avoiding the disadvantages of previous methods and devices.

The example device according to the present invention has an infrared radiation detection unit which is configured to detect numerous different material samples on the substrate using local resolution.

A local resolution detection unit of this type allows detection and testing of any material sample individually and nearly simultaneously. This ensures relatively quick measurements, i.e., shortens the time needed to measure numerous material samples, while keeping design complexity comparatively low.

The infrared radiation detection unit may be configured as an infrared camera. An especially simple exemplary embodiment of the present invention is achievable by using an imaging infrared camera. If necessary, commercially available standard components may be used, which provide an especially economical embodiment of the present invention.

The temperature evaluation unit may include at least one assignment unit for assigning one detected image section to each of the numerous different material samples.

In another exemplary embodiment, a temperature regulator is provided to regulate the temperature of the numerous different material samples. This ensures that the temperatures of the numerous different material samples are adjustable to nearly the same temperature, in particular before the measurement step. This allows, for example, an equalization of disadvantageous temperature fluctuations in the environment. The ability of the detection unit to evaluate any comparatively small temperature variations that may occur due to the reaction is also improved thereby.

The temperature regulator may include at least one heating unit. This allows implementation of a temperature regulator using commercially available standard components. Heating may be achieved by, for example, electrical heating coils, a heat exchanger, a hot heating gas conducted past the numerous material samples, a radiant heater or similar arrangement.

In another exemplary embodiment of the present invention, the temperature evaluation unit is configured to determine the emission coefficients of the numerous different material samples. This embodiment allows determination of the temperature variation or thermal radiation emitted by the measured medium much more precisely. The emission coefficients of the individual samples may be determined after adjusting the temperature or thermostatically controlling the substrate and/or the numerous different material samples. Because of the improved sensitivity of the material test achieved thereby, relatively small differences are detectable in relation to the reaction of the measured medium.

The numerous different material samples may be classified according to multiple—at least two—different classes. The material samples may be divided into one class in which no temperature variation or reaction of the measured medium was detected and into at least one class in which a temperature variation or reaction of the measured medium was detected.

The temperature evaluation unit may be configured to determine cross-sensitivities of numerous different material samples toward different measured media. For example, different measured media are brought into contact with the numerous different material samples, such as consecutively over time, so that any temperature variation, i.e., reaction of the measured medium that may occur, is detectable by the temperature evaluation unit. The material temperature is adjustable to a predefined value, or the material samples may be thermostatically controlled between applications of the different measured media to the numerous material samples.

Cross-sensitivities may be determined in the case of sensor materials for gas sensors. This exemplary embodiment may be used, in particular, to classify material samples that are especially selective toward a measured medium. These materials, for example, are particularly sensitive to the detected medium and, at the same time, have no or only minimal cross-sensitivities toward other media. For example, a cross-sensitivity toward nitrogen dioxide or similar media should be reduced as much as possible in the case of gas sensors for detecting carbon monoxide.

In another exemplary embodiment of the present invention, at least one chamber that is fillable with a measured medium is provided. For example, the infrared radiation detection unit, as well as the numerous different material samples and if necessary, the substrate, are placed in the chamber that is fillable with a measured medium.

Alternatively, the chamber may have a wall section that is at least partially permeable to infrared radiation. The wall section may be positioned between the infrared radiation detection unit and the numerous different material samples. The wall section may include at least one sapphire. As a result, the infrared radiation detection unit, in particular, is positionable outside the chamber. The chamber volume is thereby reduced so that a comparatively small amount of measured medium is used, i.e., consumed. In addition, the possibly reactive measured medium is unable to interfere with the infrared radiation detection unit.

The substrate may be configured as a wall, in particular on the side opposite the wall section. A heating unit or a heat exchanger, may be positioned on the side of the substrate diametrically opposed to the material samples.

### BRIEF DESCRIPTION OF THE DRAWINGS

FIG. 1 is a schematic representation of a construction of a device according to the present invention.

### DETAILED DESCRIPTION

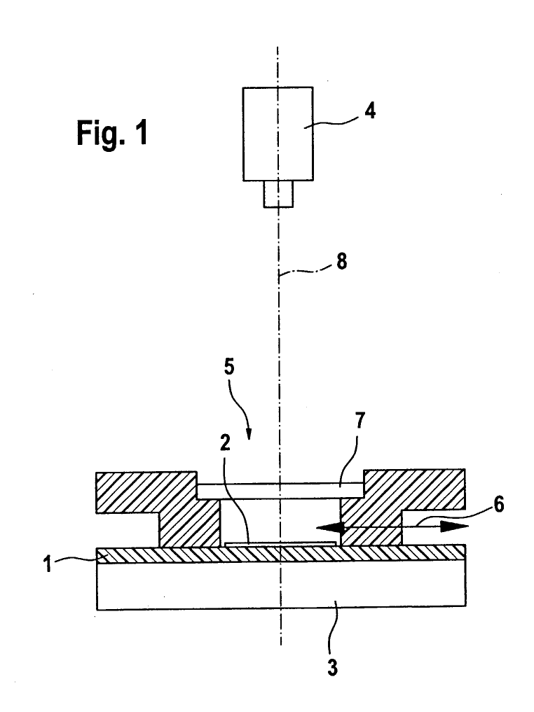

Numerous different material samples 2 of different compositions are positioned on a substrate. Substrate 1 may be made, for example, of aluminum oxide or other insulating materials. Substrate 1 is adjusted to a predetermined operating temperature, for example to a temperature between 150 and 600 degrees Celsius, in particular between 250 and 400 degrees Celsius. A heater 3 is provided for this purpose on the back of the substrate 1 as illustrated in FIG. 1. It includes, for example, electrical heating coils. The numerous different material samples 2 may also be thermostatically controlled or adjusted using a heating gas, heat exchanger or similar arrangements

Following adjustment of the operating temperature, the emission coefficients of individual material samples 2 are determined, in particular using an infrared camera 4. The nearly identical temperatures of all material samples 2 thus ensures a determination of the individual emission coefficients of different material samples 2.

A device according to the present invention can perform temperature variation detection of as little as 0.1 to 0.2 K, based on the determination of the emission coefficients of individual different material samples 2. In general, especially active sensor materials 2 experience temperature variations of up to several Kelvins due to the reaction of measured gas 6.

A chamber 5 includes, for example, a sapphire 7, which is, in particular, permeable to infrared radiation, enabling infrared camera 4 to detect the infrared light emitted by material samples 2 using local resolution. To optimize illumination, i.e., detection, infrared camera 4 is oriented nearly perpendicular to numerous different materials 2 using an optical bench 8 or similar arrangements.

After determining the emission coefficients of material samples 2, a measured gas 6 may be introduced into chamber 5 so that the gas 6 contacts the numerous different material samples 2. Upon application of gas 6 to be detected, the latter may react on the surface of material sample 2 to be tested, causing the material temperature to change. If gas 6 does not react with the material sample, the material temperature does not change. This allows for the separation of active and inactive sensor materials 2 from each other in a first screening.

In a further subsequent test, sensor materials 2 may be tested more precisely, i.e., qualitatively. The preselection of inactive material samples 2 according to the present invention, thereby separating a large number of inactive material samples 2, considerably accelerates the entire test.

If necessary, chamber 5 may be filled with different gases 6 or fluids for determining the cross-sensitivities of individual material samples 2.

What is claimed is:

1. A device for testing numerous different material samples on a substrate, comprising:
a temperature evaluation unit configured to determine a material temperature, the temperature evaluation unit including an infrared radiation detection unit configured to detect the numerous different material samples on the substrate using local resolution.

2. The device according to claim 1, wherein the numerous different material samples are catalytically active material samples.

3. The device according to claim 1, wherein the infrared radiation detection unit is configured as an infrared camera.

4. The device according to claim 1, wherein the temperature evaluation unit has at least one assignment unit to assign one of each detected image section to each of the numerous different material samples.

5. The device according to claim 1, further comprising:
a temperature regulator to regulate the temperature of the numerous different material samples.

6. The device according to claim 5, wherein the temperature regulator includes at least one heating unit.

7. The device according to claim 1, wherein the temperature evaluation unit is configured to determine respective emission coefficients of the numerous different material samples.

8. The device according to claim 1, wherein the temperature evaluation unit is configured to classify the numerous different material samples into at least two different classes.

9. The device according to claim 1, wherein the temperature evaluation unit is configured to determine cross-sensitivities of the numerous different material samples toward different measured media.

10. The device according to claim 1, further comprising:
at least one chamber filled with a measured medium.

11. The device according to claim 10, wherein the chamber includes a wall section that is at least partially permeable to infrared radiation.

12. The device according to claim 11, wherein the wall section is positioned between the infrared radiation detection unit and the numerous different material samples.

13. The device according to claim 11, wherein the wall section includes at least one sapphire.

14. A method for testing numerous different material samples on a substrate, comprising:
determining a material temperature of the numerous different material samples using local resolution by a temperature evaluation unit configured with an infrared radiation detection unit.

15. The method according to claim 14, wherein the numerous different material samples are catalytically active material samples.

16. The method according to claim 14, further comprising:
adjusting the temperature of the numerous different material samples;
determining, in a first measurement step, emission coefficients of the numerous different material samples; and
testing, in a second measurement step, the numerous different material samples.

17. The method according to claim 16, further comprising:
classifying the numerous different material samples after testing into at least two different classes.

18. The method according to claim 14, further comprising:
performing multiple tests using different measured media to determine cross-sensitivities.
